(19) United States
(12) Patent Application Publication
(10) Pub. No.: US 2010/0293459 A1
(43) Pub. Date: Nov. 18, 2010

(54) Methods and Systems for Providing a Theme to a Graphical User Interface

(75) Inventors: Jeremy Ziegler, Pflugerville, TX (US); Carrie Lea Quintanilla, Cedar Park, TX (US)

Correspondence Address: GARRANA TRAN LLP, 2000 Bering Road, Suite 150, HOUSTON, TX, 77057, US

(73) Assignee: DELL PRODUCTS L.P., Round Rock, TX (US)

(21) Appl. No.: 12/467,465

(22) Filed: May 18, 2009

(51) Int. Cl. G06F 17/00

(52) U.S. Cl. 715/275

(57) ABSTRACT

A method for providing a theme to a graphical user interface (GUI) executed on an information handling system (IHS) is disclosed, the method including receiving data associated with a first base color and generating data associated with a first gradient color from the first base color. The method further includes automatically applying a first color theme to the GUI using the data associated with the first gradient color and the data associated with the first base color. An information handling system (IHS) including a processor and memory in communication with the processor is further disclosed. The memory is operable to store a graphical user interface (GUI) and a theme managing program, wherein the theme managing program is configured to receive data associated with a base color and automatically apply a color theme to the GUI based on the base color.

### TECHNICAL FIELD

The present disclosure relates generally to the field of information handling systems, and more specifically, to providing a theme to a graphical user interface in an information handling system.

### BACKGROUND

As the value and use of information continues to increase, individuals and businesses seek additional ways to process and store information. One option available to users is an information handling system (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In today's IHS industry, various methods may exist for companies to gain a competitive advantage. One idea in particular may focus on personalization and customization of an IHS for the user. To this end, coloring matches between the hardware and the software may provide significant differentiation and a feeling of personalization. For example, for a given IHS, outer hardware components such as the chassis, monitor bezel, keyboard, and/or the like may be painted of a first color. In order to match such outer components, the appearance of certain software, such an operating system (OS), and/or a graphical user interface (GUI) may also implement the first color. For instance, certain windows, buttons and other graphical components may be colored with the first color or any variant of the first color.

However, in the current industry, many different types of colorization may be possible. Furthermore, the colorization of the IHS may be constantly changing as tastes concerning the style and look of the IHS can vary. In contrast, typical methods for achieving a matching colorization of software components may not be as flexible and adaptable to the physical hardware portions of an IHS. Particularly, to create a new colorization for a GUI, a new color theme that is compatible with the GUI may need to be created. Creating a new theme may prove to be a time consuming process that requires a user to manually change the colorization of individual graphical components of the GUI.

Thus, a need exists for methods and systems that would automatically create a color theme using a base color and gradients of the base color. Further, the methods and systems may apply such color theme throughout a given GUI.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the present disclosure provides a method for providing a theme to a graphical user interface (GUI) executed on an information handling system (IHS). The method includes receiving data associated with a first base color and generating data associated with a first gradient color from the first base color. The method further includes automatically applying a first color theme to the GUI using the data associated with the first gradient color and the data associated with the first base color.

Another aspect of the disclosure provides an information handling system (IHS) including a processor and memory in communication with the processor. The memory is operable to store a graphical user interface (GUI) and a theme managing program, wherein the theme managing program is configured to receive data associated with a base color and automatically apply a color theme to the GUI based on the base color.

Yet another aspect of the disclosure provides for a method for managing themes of a graphical user interface (GUI) executed on an information handling system (IHS) whereby the method includes receiving data associated with a new base color. The method further includes generating data associated with a new gradient color based on the new base color and automatically applying the new base color and the new gradient color to a master theme having a default base color and a default gradient color.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents an information handling system (IHS) in accordance with one aspect of the present disclosure;

FIG. 2 represents graphical user interface (GUI) on a portable IHS in accordance with one aspect of the present disclosure;

FIG. 3 represents a theme managing program for the GUI of FIG. 2;

FIG. 4 provides a flow diagram illustrating a method for providing a theme to a GUI in an IHS in accordance with one aspect of the present disclosure; and

FIG. 5 provides a flow diagram illustrating a method for managing themes of a GUI in an IHS in accordance with one aspect of the present disclosure.

### DETAILED DESCRIPTION

Before the present systems and methods are described, it is to be understood that this disclosure is not limited to the particular systems and methods described, as such may vary. One of ordinary skill in the art should understand that the terminology used herein is for the purpose of describing possible aspects, embodiments and/or implementations only, and is not intended to limit the scope of the present disclosure which will be limited only by the appended claims.

It must also be noted that as used herein and in the appended claims, the singular forms “a,” “and,” and “the” may include plural referents unless the context clearly dictates otherwise. Thus, for example, reference to “a gradient color” refers to one or several gradient colors, and reference to “a method of managing” includes reference to equivalent steps and methods known to those skilled in the art, and so forth.

This disclosure is not limited in its application to the details of construction and the arrangement of components set forth in the following description or illustrated in the drawings. The disclosure is capable of other embodiments, implementations or aspects and of being practiced or of being carried out in various ways. Also, the use of “including,” “comprising,” “having,” “containing,” “involving,” “consisting” and variations thereof, is meant to encompass the items listed thereafter and equivalents thereof as well as additional items.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

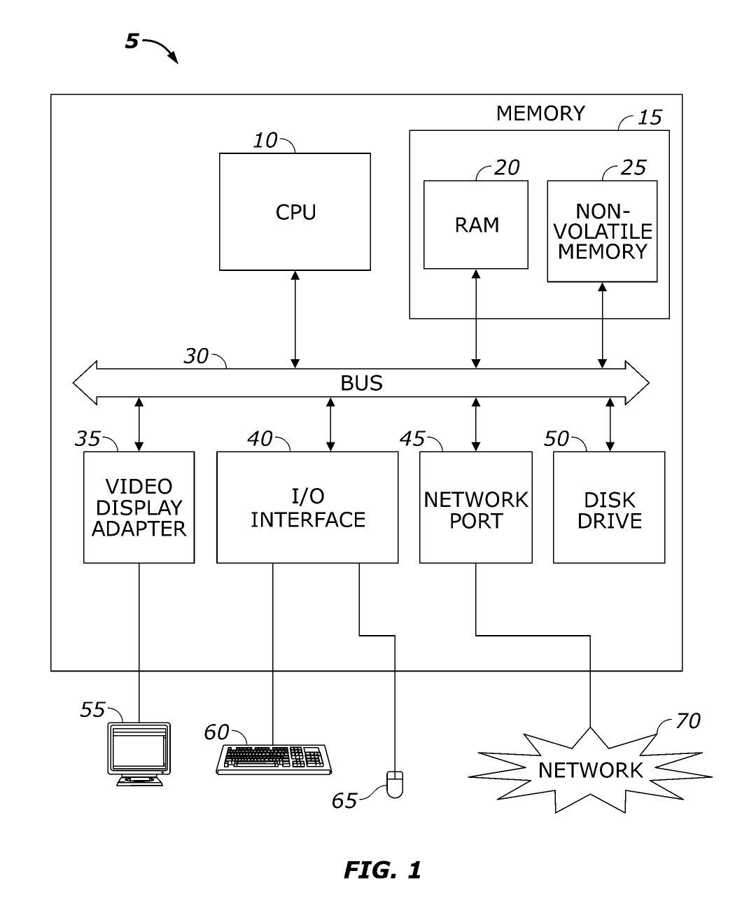

FIG. 1 illustrates one possible implementation of an IHS 5 comprising a CPU 10. It should be understood that the present disclosure has applicability to IHSs as broadly described above, and is not intended to be limited to the IHS 5 as specifically described. The CPU 10 or controller may comprise a processor, a microprocessor, minicomputer, or any other suitable device, including combinations and/or a plurality thereof, for executing programmed instructions. It is appreciated that execution of the algorithm to be described below occurs in the processor or the CPU 10. The CPU 10 may be in data communication over a local interface bus 30 with components including memory 15 and input/output interfaces 40. The memory 15, as illustrated, may include non-volatile memory 25. The non-volatile memory 25 may include, but is not limited to, flash memory, non-volatile random access memory (NVRAM), and electrically erasable programmable read-only memory (EEPROM). The non-volatile memory 25 may contain a firmware program (not shown) which may contain programming and/or executable instructions required to control a keyboard 60, mouse 65, video display 55 and/or other input/output devices not shown here. This type of firmware may be known as a basic input/output system (BIOS). The memory may also comprise random access memory (RAM) 20. The operating system and application programs (e.g., graphical user interfaces) may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

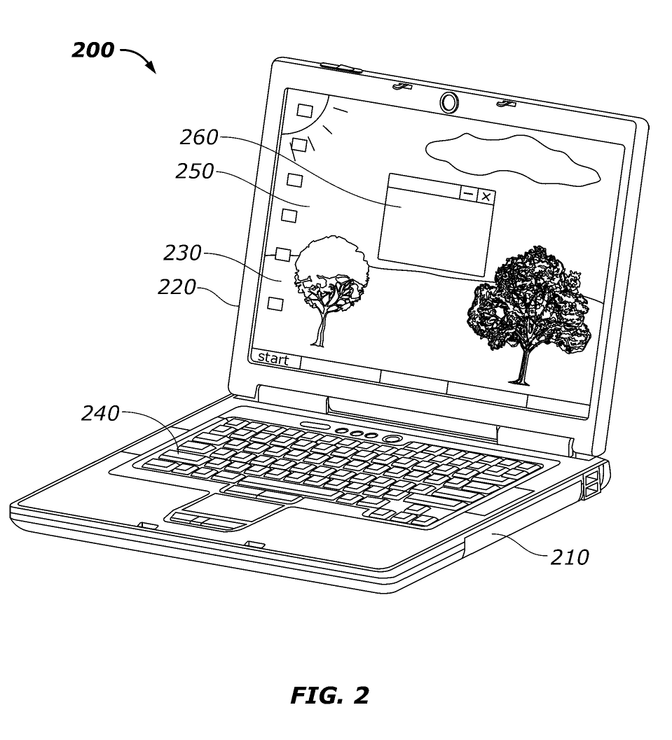

Turning now to FIG. 2, a schematic is provided of a graphical user interface on a portable IHS 200 in accordance with one aspect of the present disclosure. As illustrated, the portable IHS 200 may include a chassis 210 that encloses various hardware components of the portable IHS 200. For example, memory, hard disk drives, optical drives, the CPU, and/or the like may be enclosed within the chassis 210. Additionally, the portable IHS 200 may include a keyboard 240 and display 220. Notably, the chassis 210, keyboard 240, or the like, may all be painted or otherwise colorized.

As further depicted in FIG. 2, a graphical user interface (GUI) 250 may be displayed on a display 220 or monitor of the portable IHS 200 for an operating system (OS) to interact with a user. A GUI, executed on an IHS, may enable a user to interact with the OS and therefore interact and control an IHS. Additionally, the GUI may be included in the OS and may be stored in memory, a hard drive, or any other storage device. Currently, GUIs may be designed to create a graphical environment that resembles working at a desk. Typically, such GUIs may employ a window environment, which provides a user specifically defined portions of the screen or display called windows. The windows may be capable of functioning independently, and each window may represent a different application, program, file, document, and/or the like.

Typically, the windows may have a top to bottom order in which they may be displayed, with top windows at a particular location on the screen overlaying any other window at the same location. The top-most window may be said to have the “focus” and may accept input from a user. Furthermore, a user may switch focus to another window by clicking on the window with a mouse or any other pointer device, or by inputting certain key combinations. Thus, users may be able to work with multiple applications, programs, files, and/or the like on the portable IHS 200.

The desktop 230 of the GUI may provide a screen containing icons, which may represent programs, files, resources, and any other applications available to the user. As such, the desktop 230 may act as a launching point for executing applications and programs, opening documents or files, and/or initiating other operating system services. The idea of the desktop 230 may be to simulate the top of an actual desk on which various work items may be made available to the user. The desktop in some GUIs may thus include icons representing work resources found on an actual desk, with different programs representing physical resources such as a file cabinet, telephone, wastebasket, scratchpad, and/or the like. As such, the icons may be activated by the user to execute applications or programs that act as computer equivalents of the actual work resource. In typical GUIs, the desktop may constantly remain as a full-screen background relative to the windowing environment. In other words, the desktop cannot be moved or resized, and all visible windows of the windowing environment overlay the desktop. The desktop may thus effectively provide a graphical work surface underlying the windowing environment.

Moreover, the GUI 250 may be associated with a master theme 260 to enhance its look and provide a unique experience to the user. As used herein, a master theme 260 may refer to an overall visual appearance of the GUI 250, or in other words, the style of its graphical components. To this end, the master theme 260 may define how certain graphical components, including, but not limited to, windows, buttons, taskbars, and icons, are drawn on a display. For example, different themes may result in such graphical components being drawn as different shapes and/or different sizes. Furthermore, the colorization of such graphical components may also vary with the master theme 260. In addition, the master theme may include a background which may provide a visual backdrop for the entire GUI 250 and which may be part of the desktop 230.

In one implementation, the colorization of the graphical components of the GUI may match that of chassis 230, keyboard 240, monitor bezel 220, and/or other hardware components of the portable IHS 200. To this end, a particular way of colorizing the graphical components may be referred to as a color theme. A color theme may then be incorporated with and applied to a master theme to provide a complete visual environment and experience to a user.

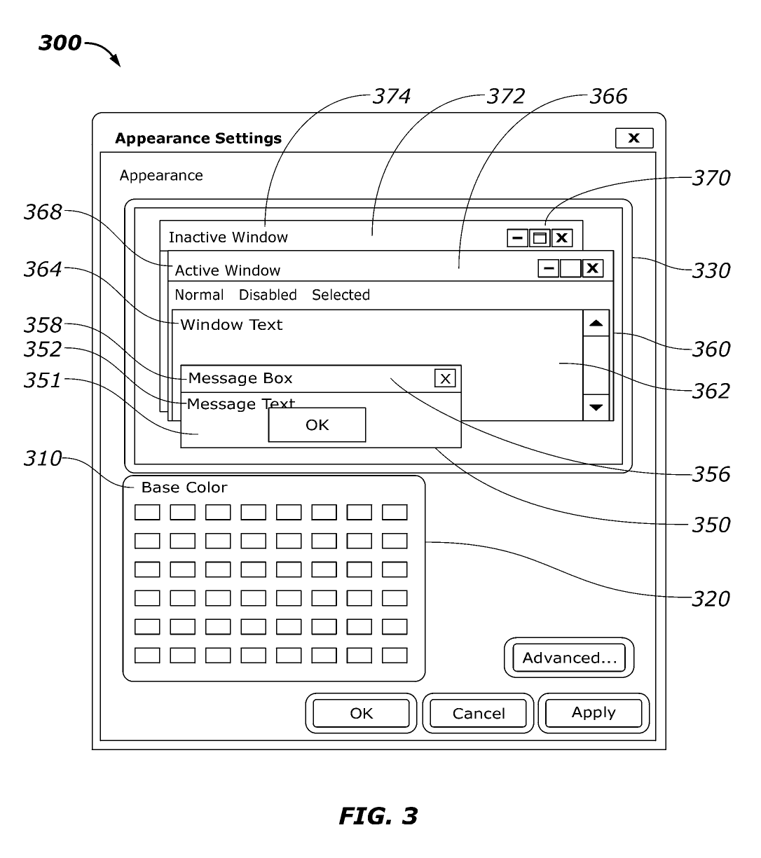

FIG. 3 depicts a theme managing program 300 that enables the user to select a color theme for the entire GUI of FIG. 2. The theme managing program 300 may be stored on any storage device including, but not limited to, memory, hard drives, and optical storage devices. In general, the theme managing program may enable a user to change or modify the visual appearance of the GUI by changing or altering master themes, color themes, and/or the like. As illustrated in FIG. 3, the user may be able to select a base color 310 to from a basis for the color theme 330. Typically, the base color 310 or any color in an IHS may be represented by a Red, Green, Blue (RGB) number of the RGB color model. Generally, the RGB color model may represent an additive color model in which red, green, and blue light may be added together in various ways to reproduce a broad array of colors. Therefore, the RGB color model may provide an effective way for sensing, representing, and displaying images in an IHS.

To form a color in an IHS under the RGB color model, three colored light beams i.e., one red, one green, and one blue may be superimposed within a display of an IHS. Therefore, the RGB color model may be said to be “additive” in the sense that the three light beams may be added together. In other words, their light spectra may be added wavelength for wavelength to make the final color's spectrum. As such, these light beams may be emitted from a black display or screen or may be reflected off of a white screen. Each of the three beams may be referred to as a component of that color, and each component may have an arbitrary intensity, from a fully off state to a fully on state. To this end, the intensity of a particular component, i.e., red, green, or blue may be represented by an RGB number. The red, green, and blue colors of the RGB color model may also be referred to as the primary colors.

An indication of zero intensity for each component may represent the darkest color or no light, which may be considered black. On the other hand, full intensity of each component may represent white. Furthermore, when the intensities for all the components are the same, the result may be a shade of gray, darker or lighter depending on the intensities. For example, the closer the intensities may be to zero, the darker the shade of gray may be. When the intensities among the components are varied, a colorized hue may then be formed. Such a hue may become more or less saturated depending on the difference between the strongest and weakest of the intensities of the components employed. In this manner, different colors may be represented and displayed on a screen.

In addition, if one of the components is represented at its strongest intensity while the other components have an intensity of zero, the final color represented may be the component at the strongest intensity. For example, if red is represented at its strongest intensity while green and blue each have an intensity of zero, then the final color would be red at its strongest intensity. If two components are at their strongest intensities, then the color represented may be a secondary color, i.e., cyan, magenta, or yellow. To this end, green mixed with blue, each at its highest intensity, may yield cyan, red and blue may yield magenta, and red and green may yield yellow. Again, all three colors at their strongest intensities may yield white.

As previously mentioned, the RGB number may describe the intensity of each component of red, green, and/or blue light. As such, the RGB number may be expressed as a triplet (r,g,b) with each component, r, g, and b having a value from zero to a defined maximum value. Furthermore, the RGB triplet may also be expressed in various ways. For example, in arithmetic notation, each component may be represented by a number from zero to one, with any fractional value in between. The color red at full intensity may thus be represented by the triplet (1.0, 0.0, 0.0). In another implementation, the RGB number may be represented by 8-bit or 16-bit integers with ranges from 0 to 255 and 0 to 65535, respectively. In an 8-bit representation, the color red at full intensity may therefore be denoted by the triplet (255, 0, 0) while for a 16-bit representation, a full red may be denoted by the triplet (65535, 0, 0).

Referring back now to the base color 310, the user may select the base color 310 from a color palette 320 containing numerous colors. It should be noted that the number of colors provided by the color palette is not limited to those shown in FIG. 3. Therefore, any number of colors may be provided in the color palette 320, and furthermore, any color may be provided by the color palette 320. In another implementation, the user may have the option of manually entering the RGB number of the base color 310 desired. Thus, the user may effectively create a custom base color 310 according to preferences.

Once selected and/or entered, the base color 310 may define the basis of the color theme 330 to be implemented for the GUI. As depicted by FIG. 3, the color theme 330 may define the colors of various graphical components in the GUI. For example, the color theme 330 may provide colorization for a background 340, a message box 350, an active window 360, and an inactive window 370. It should be noted that the color theme 330 is not limited to providing colorization for these particular objects and that other graphical components may also be colorized by the color theme 330.

For the message box 350, the color theme 330 may provide colorization for a message box body 354 as well as a message box body text 352. Generally, a message box may prompt a user with an input choice(s) from which the user can choose to perform a particular action. Additionally, colorization may also be provided for a message box title bar 356 and a message box title bar text 358. In general, a title bar for any window may be located at the top of the window and may provide the title or name for the application represented by the window

The GUI may also contain other windows such as an active window 360 and an inactive window 370. The active window 360 may represent the window (i.e., the application or program) that a user may be currently manipulating or engaged with. As such, the active window 360 may be said to have “focus” and may be on top. As previously mentioned, a window may gain active window status when a user clicks on the window with a mouse or otherwise focuses on the window such as with a combination of keystrokes, for example. Moreover, various parts of the active window 360 may be colorized, such as an active window body 362, an active window body text 364, an active window title bar 366, and an active window title bar text 368.

In contrast to the active window 360, an inactive window 370 may refer to any window not currently in focus or on top. The portions of the inactive window 370 to be colorized by the color theme 330 may include, but are not limited to, an inactive window title bar 372 and an inactive window title bar text 374.

In one implementation, the various graphical components i.e., the background 340, message box 350, active window 360, inactive window(s) 370, or the like, may be colorized by set gradient offsets of the base color 310, whereby the gradient offsets are generated by the theme managing program 300. In other words, the color theme 330 may define the gradient offsets from the base color 310 for each graphical component. In general, the gradient of a particular color may refer to a shade or hue of the color ranging from a lighter shade of the color to a darker shade of the color. In an RGB number representation, different gradient colors of a base color 310 may be represented by different intensities of the base color 310. For example, different gradients of red may be represented by varying intensities of the red component in the RGB triplet and can range from lighter reds at lower intensities to darker reds (e.g., maroon) at higher intensities.

Furthermore, the gradient shifts among the different graphical components in the GUI may be preset or programmed regardless of the base color 310. As such, the theme managing program 300 may systematically colorize each graphical component by applying gradient offsets in the intensities of its red, green, and blue components from those of the base color 310. To this end, a color theme 330 may be created by the mere selection of a base color 310 since such a selection may already define the gradient offsets, and therefore the colorization, of all relevant graphical components. For instance, if a user selects red as a base color 310, the theme managing program 300 may receive the data associated with the red base color 310. The theme managing program 300 may then generate gradient colors and offsets from the base color 310 and may apply a color theme 330 to the GUI using both the base color 310 and the gradient colors. As such, different graphical components may be colorized by different gradient colors and/or the base color 310. Using red in the current example, the background 340 may be colorized with a gradient of red, e.g., either higher or lower intensity. Similarly, other graphical components such as the message box 350, active window 360, and inactive window(s) 370 may also be colorized with their own respective gradients of red.

It should be noted that while FIG. 3 is depicted with a certain master theme i.e., the particular shapes, sizes, and styles of the windows, buttons, and the like, other master themes are also contemplated within the present disclosure. As such, other color themes 330 that may colorize those master themes are also contemplated.

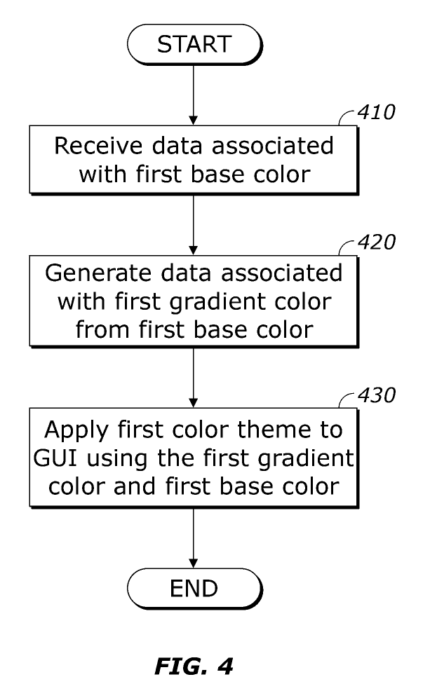

Turning now to FIG. 4, a flow diagram is provided that illustrates a method 400 for providing a color theme to a GUI displayed on an IHS in accordance with one aspect of the present disclosure. The method may begin in step 410 where data associated with a first base color is received. In one implementation, the data may be received when a user selects a first base color as the base color for a desired color theme. As previously mentioned, such a selection may be performed by the user selecting the first base color from a palette of colors or by any other means such as inputting an RGB number for the first base color, for example. Furthermore, in some instances, the first base color may be chosen to match the color of certain hardware components of an IHS. For example, the first base color may be chosen to match a chassis color of a chassis enclosing the IHS. Matching colors in this manner may provide an end user with the notion that hardware and software are packages as a holistic unit and therefore imply stylistic and functional compatibility.

Next, in step 420, data (RGB number, triplet value) associated with a first gradient color may be generated from the first base color. As previously mentioned, the first gradient color may be applied to certain graphical components of the GUI such as message boxes, active windows, inactive windows, backgrounds, icons, and/or the like. Furthermore, the first gradient color may be generated as a gradient offset from the first base color. In implementations where colors in the IHS are represented by RGB numbers, a gradient offset may be a mathematical function of the RGB representing the first base color. For example, in one implementation, once data associated with the first base color is received in step 410, i.e., the RGB number for the first base color, an active window title bar may be colorized by applying a function that halves the intensity of all components in first base color's RGB number. Such a function may be performed to colorize the active window title bar regardless of the base color chosen. Furthermore, other graphical components may be colorized using other functions to generate more gradient colors of the first base color. Consequently, an entire color theme may be created and applied by inputting a single base color.

In step 430, a color theme employing the first gradient color and the first base color may be automatically applied to the GUI such that certain graphical components may be colorized with the first gradient colors while other graphical components may be colorized with the first base color. As used herein, automatically may mean that upon receiving a base color from the user, gradient offsets may be generated to form a color theme, which may be applied to the GUI without any user intervention. Thus, the user need only input a base color to create and apply a color theme to a GUI.

It should be noted that the present disclosure is not limited to one gradient color, and any number of other gradient colors are also contemplated. As such, the graphical components of the GUI may be colorized by many different gradient colors and/or the base color. For example, a message box title bar may be colorized with a first gradient color while an active window body may be colorized with a second gradient color. Still further, the background of the GUI may be colored with the first base color.

Furthermore, the method 400 also provides a means to change the color theme simply by inputting a different base color. For example, if a different color theme based on a different based color is desired, a user may input a second base color. Subsequently, data associated with the second base color may be received, similar to step 410, and data associated with a gradient color may be generated from the second base color. Finally, a second color theme, using the second gradient color and the second base color, may be applied to the GUI.

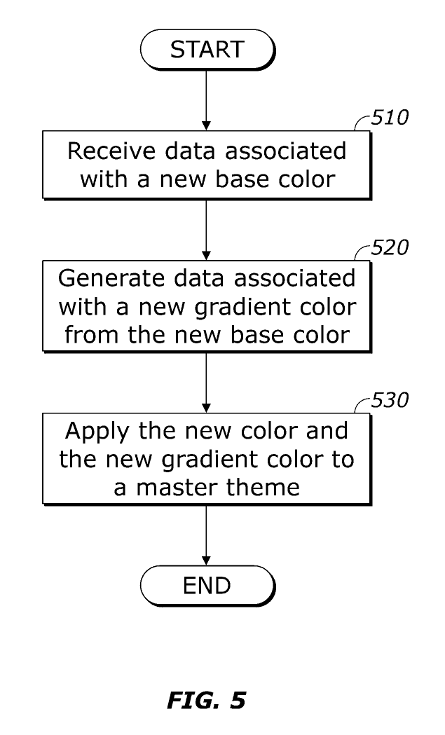

Turning now to FIG. 5, a method 500 for managing themes of a GUI in an IHS is provided in accordance with another aspect of the present disclosure. The method 500 may begin in step 510, where data associated with a new base color is received. As previously mentioned, such data may be received after input of a base color selection by a user. In step 520, data (RGB number, triplet value) associated with a new gradient color may be generated from the new base color. Then, in step 530, the new base color and the new gradient color may be automatically applied to master theme, i.e., without user intervention as explained above. Notably, the master theme may have previously included a default base color and a default color gradient. Thus, the master theme may have its default base color and default color gradient changed to the new base color and the new color gradient by inputting the new base color.

Thus, methods and a system are provided for automatically applying and/or changing a color theme to a GUI in an IHS. Rather than manually selecting graphical components to colorize and manually selecting a color for the components, an entire color theme may be created by simply inputting a base color. Gradient colors may then be generated from the base color and applied to various graphical components according to set gradient offsets. Therefore, color themes may be applied to a GUI with relative ease and efficiency.

Although the present disclosure has been described with reference to particular examples, embodiments and/or implementations, those skilled in the art will recognize that modifications and variations may be made without departing from the spirit and scope of the claimed subject matter. Such changes in form and detail, including use of equivalent functional and/or structural substitutes for elements described herein, fall within the scope of the appended claims and are intended to be covered by this disclosure.

Furthermore, methods of the present disclosure, detailed description and claims may be presented in terms of logic, software or software implemented aspects typically encoded on a variety of media or medium including, but not limited to, computer-readable medium/media, machine-readable medium/media, program storage medium/media or computer program product. Such media may be handled, read, sensed and/or interpreted by an IHS. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

What is claimed is:

1. A method for providing a theme to a graphical user interface (GUI) executed on an information handling system (IHS), the method comprising:
receiving data associated with a first base color;
generating data associated with a first gradient color from the first base color;
automatically applying a first color theme to the GUI using the data associated with the first gradient color and the data associated with the first base color.

2. The method of claim 1, wherein receiving data associated with the first base color comprises receiving data associated with a Red, Green, Blue (RGB) number representing the first base color.

3. The method of claim 1, wherein generating the data associated with the first gradient color comprises applying a gradient offset to the first base color.

4. The method of claim 1, wherein receiving data associated with the first base color comprises receiving the data from a selection of the first base color from a color palette.

5. The method of claim 1 further comprising receiving data associated with a second base color and generating data associated with a second gradient color based on the second base color.

6. The method of claim 5 further comprising automatically applying a second color theme to the GUI using the data associated with the second base color and the data associated with the second gradient color.

7. The method of claim 1, wherein the first base color is based on a chassis color of a chassis enclosing the IHS.

8. An information handling system (IHS) comprising:
a processor;
memory in communication with the processor, the memory operable to store a graphical user interface (GUI) and a theme managing program, wherein the theme managing program is configured to receive data associated with a base color and automatically apply a color theme to the GUI based on the base color.

9. The system of claim 8, wherein the data associated with the base color is input by a user into the theme managing program.

10. The system of claim 8, wherein the data associated with the base color is represented by a Red, Green, Blue (RGB) number.

11. The system of claim 8, wherein the data associated with the gradient color is represented by a gradient offset of the base color.

12. The system of claim 8 further comprising a chassis enclosing the IHS, the chassis associated with a chassis color, wherein the base color is based on the chassis color.

13. The system of claim 8, wherein the theme managing program is further configured to generate data associated with a first gradient color from the first base color.

14. The system of claim 13, wherein the theme managing program is further configured to automatically apply a first color theme to the GUI using the data associated with the first gradient color and the data associated with the first base color.

15. The system of claim 8, wherein the data associated with the base color is selected from a color palette.

16. A method for managing themes of a graphical user interface (GUI) in an information handling system (IHS), the method comprising:
receiving data associated with a new base color;
generating data associated with a new gradient color based on the new base color; and
automatically applying the new base color and the new gradient color to a master theme having a default base color and a default gradient color.

17. The method of claim 16, wherein receiving data associated with the new base color comprises receiving data associated with a Red, Green, Blue (RGB) number.

18. The method of claim 16, wherein generating the data associated with the new gradient color comprises applying a gradient offset to the new base color.

19. The method of claim 16, wherein receiving the data associated with the new base color comprises receiving the data from a selection of the new base color from a color palette.

20. The method of claim 16, wherein the new base color is based on a chassis color of a chassis enclosing the IHS.
